(19) United States
(12) Patent Application Publication
(10) Pub. No.: US 2005/0114487 A1
(43) Pub. Date: May 26, 2005

(54) Notification framework and method of distributing notification

(76) Inventors: Jin Peng, Belleville (CA); Xin Zhao, Belleville (CA)

Correspondence Address: Ridout & Maybee LLP;One Queen Street East, Suite 2400, Toronto, ON, M5C 381, CA

(21) Appl. No.: 10/705,603

(22) Filed: Nov. 12, 2003

(51) Int. Cl. G06F 15/173

(52) U.S. Cl. 709/223

(57) ABSTRACT

A notification framework for distributing notice of the occurrence of an event. The framework receives a event message from an event generator regarding an event, encapsulates the event content within an event envelope, and distributes the event envelope to registered event listeners entitled to receive notice of the event. The notification framework is Web Service based. It provides for publication and discovery of event sources through Web Service interfaces. Event listener policies and event source policies act as filters imposing restrictions and conditions upon the event listeners entitled to notice of an event.

### FIELD OF THE INVENTION

This invention relates to network management and, more particularly, to notification services.

### BACKGROUND OF THE INVENTION

Modern networks are growing in complexity, often resulting in a mix of network management systems spanning multiple domains. In response to this growing complexity and in order to provide for a uniform and extensible standard for interoperating between different software applications running over a variety of frameworks and/or platforms, the World Wide Web Consortium (W3C™) has developed the Web Services Architecture and the extensible Markup Language (XML). These tools assist in providing standards and protocols for developing heterogeneous, interoperable, loosely-coupled, and implementation-independent programs, but do not specify how Web Services might be implemented or combined or for what purposes.

Accordingly, a remaining challenge for network engineers is to provide the ability to communicate state change information asynchronously between systems running on heterogeneous platforms.

Existing notification protocols rely upon manual discovery of event types and event generators by event listeners. The event listeners then typically register with the event generator to receive notice of an event occurrence. This model has significant limitations in that the event listeners must adapt to the semantics and protocols of each event generator that they wish to monitor.

Other approaches that have been developed include Simple Network Management Protocol (SNMP), ITU-T Telecommunication Manage Network (TMN), and Microsoft COM+ Event Service. These approaches fail to provide an adequate solution for a number of reasons including reliance upon proprietary technology, insufficient flexibility in defining event types and providing extensibility, lack of loosely-coupled design, and manual publication and discovery of event sources.

Accordingly; a need continues to exist for a notification framework that communicates event information asynchronously between systems running on heterogeneous platforms.

### SUMMARY OF THE INVENTION

The present invention provides a notification framework that receives a raw event message from an event generator regarding an event, encapsulates the event content within an event envelope, and distributes the event envelope to registered event listeners entitled to receive notice of the event. The notification framework is Web Service based. It provides for publication and discovery of event sources through Web Service interfaces.

In one aspect, the present invention provides a method of distributing notification regarding an event from an event generator to an event listener in a network environment. The method includes the steps of receiving an event message from the event generator, the event message being Web Service based and including an event source element and an extensible event content element; creating an event envelope containing the event content element; identifying the event listener as a registered, event listener entitled to receive notice of the event; and transmitting the event envelope to the event listener.

In a further aspect, the present invention provides a notification framework for distributing notification regarding an event from an event generator to an event listener in a network environment. The notification framework includes an event handler for receiving an event message from the event generator, the event message being Web Service based and including an event source element and an extensible event content element, and encapsulating the event content element in an event envelope; an event listener library identifying registered event listeners entitled to receive notice of the event, wherein the registered event listeners include the event listener; and an event policy library including an event policy element for transmitting the event envelope to the event listener.

In yet a further aspect, the present invention provides a computer program product having a computer readable medium tangibly embodying computer executable instructions for distributing notification regarding an event from an event generator to an event listener in a network environment. The computer executable instructions include computer executable instructions for receiving an event message from the event generator, the event message being Web Service based and including an event source element and an extensible event content element; computer executable instructions for creating an event envelope containing the event content element; computer executable instructions for identifying the event listener as a registered event listener entitled to receive notice of the event; and computer executable instructions for transmitting the event envelope to the event listener.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Reference will now be made, by way of example, to the accompanying drawings which show an embodiment of the present invention, and in which:

FIG. 1 shows a diagrammatic representation of an embodiment of a notification framework;

FIG. 2 diagrammatically shows the structure of an-event forwarding policy element;

FIGS. 3(a) and (b) diagrammatically show the structure of a raw event element and of an event envelope element, respectively; and

FIGS. 4(a) and (b) show flowcharts for a method of distributing notification regarding an event from an event generator to an event listener in a network environment.

Similar reference numerals are used in the figures to denote similar components.

### DESCRIPTION OF SPECIFIC EMBODIMENTS

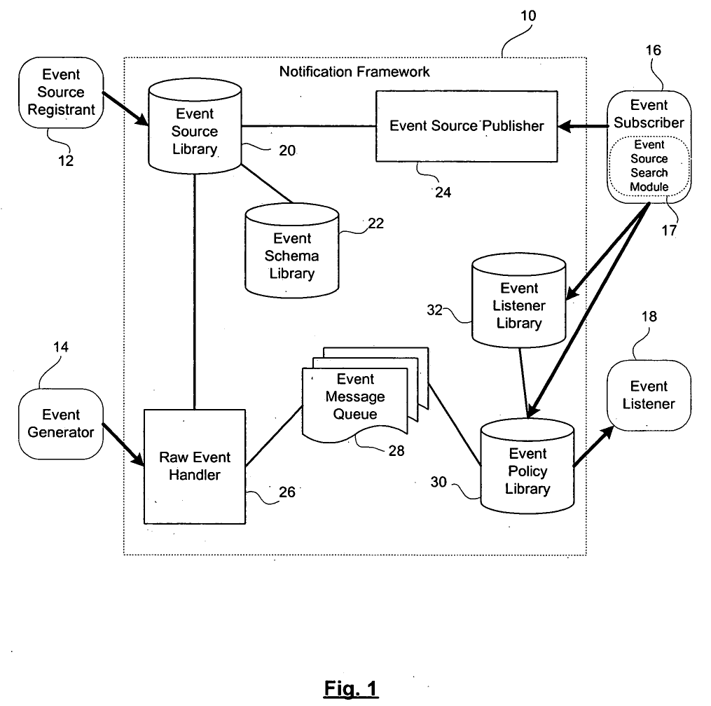

Reference is first made to FIG. 1, which shows a diagrammatic representation of an embodiment of a notification framework 10 according to the present invention. The notification framework 10 includes an event source library 20, an event schema library 22, and an event source publisher 24, which may collectively be referred to as the signalling path for the notification framework 10. The notification framework 10 also includes a raw event handler 26, an event message queue 28, an event policy library 30, and an event listener library 32, which may be collectively referred to as the media path. The event listener library 32 may alternatively be considered part of the signalling path.

The signalling path is the portion of the notification framework 10 for registering events and event generators, for publishing event sources and for enabling event listener discovery and registration of event sources. The media path is the portion of the notification framework 10 for receiving event messages from event generators and managing the distribution of notification messages to event listeners according to event policies.

An event source registrant 12 registers an event source with the event source library 20. The event source specifies an event generator 14. An event subscriber 16 discovers available event sources through Web Service interfaces provided by the event source publisher 24. Having discovered an event source from which notice is desired, the event subscriber 16 registers an event listener 18 to receive notice from the notification framework 10 when an event is received from the event source. Although the event source registrant 12 and the event generator 14 may be the same entity, they may be different entities. They are shown as distinct entities in FIG. 1 to emphasize the conceptual difference between the registration-publication-discovery phase conducted through the signalling path and the event generation-notification phase conducted through the media path. Similarly, the event subscriber 16 and the event listener 18 may be distinct entities or may be the same entity. They are shown as distinct entities in FIG. 1 to emphasize the conceptual distinction between them.

The notification framework 10 uses Web Service and extensible Markup Language (XML) to provide for a flexible, extensible system with a consistent interface. The use of XML allows the notification framework 10 to provide a generic event model, which supports the later addition of new event types.

In the signalling path, the event source library 20 receives and stores event sources. An event source is defined by at least two parameters: an event generator address and a corresponding namespace URI. The event generator address can be any string that is unique within an administrative domain for identifying the event generator 14. The namespace URI identifies an XML Schema Definition (XSD) Language document which defines the structure and semantics of the event type generated by the corresponding event generator. Each event type, or each group of related event types, has an XSD document defining the structure of an XML document containing event information or content. Each of these XSD documents is identified by its namespace URI. Based upon the namespace URI one can assess what type of event is represented by the event source. Based upon the XSD document, one can determine precisely the type of event and the nature and structure of the information regarding the event that is generated by the event generator. Accordingly, an event source identifies the type of event that the source generates by specifying an XSD document and identifies the event generator that is to be the source of the event.

Each XSD document is stored in the event schema library 22 and is accessible through its associated namespace URI. An XSD document is used to validate the content of an event.

The event source publisher 24 makes the list of event sources available through Web Service interfaces. Accordingly, potential event subscribers may access the list of available event sources and obtain their event generator addresses and their namespace URIs. Using the namespace URI, the event subscribers may also access the corresponding XSD document. The event source publisher 24 further provides event source search functions. For example, given a target namespace URI, the event source publisher 24 may provide the event subscriber 16 with a list of all event sources corresponding to the target namespace URI.

Based upon the namespace URIs, the event generator addresses, or the XSD documents themselves, an event subscriber 16 can determine if the event source is one from which the event listener 18 should receive notice. In fact, this process can be partially or fully automated. The event subscriber 16 may include an event source search module 17, which periodically assesses whether the event source publisher 24 has publicized a new event source. The adding of a new event source may itself constitute a state change event that results in notice being given to the event listener 18. Each time a new event source is generated, the notification framework 10 notifies the event listeners 18/event subscribers 16 that have registered to receive notice of such events.

When a new event source is identified, the event source search module 17 may obtain the event source information for manual evaluation. The event source search module 17 may also perform screening or pre-filtering of potential new event sources based upon certain criteria, such as categories of event types that are of interest. In another embodiment, the event source search module 17 may automatically trigger the registration process described below with respect to new event sources meeting prescribed criteria. Other automated functions may be performed by the event source search module 17 to take advantage of the publication of event sources by the event source publisher 24 through Web Service interfaces.

Once the event subscriber 16 has identified one or more relevant event sources, it may register an event listener 18 with the event listener library 32. The registration with the event listener library 32 includes the URL of the event listener and a list of namespace URIs that the listener is capable of understanding, as will be described in greater detail below. The namespace URIs identify the event types that the event listener 18 wishes to monitor. In order to understand the event content communicated by the notification framework 10 with respect to these event types, the event listener 18 imports the corresponding XSD documents, as is further described hereinafter.

The registration in the event listener library 32 represents the event listener's 18 capability of consuming certain types of events. This information can be used in concert with the event source registrations in the event source library 20 to perform automated matchmaking. Based upon the capability of registered event listeners 18 to consume certain types of events and the types of events generated by particular event generators 14, automatic event forwarding policies may be developed, as is described in greater detail below.

In order to have the capability of receiving notifications from the notification framework 10, the event listener 18 implements a Listener Web Service interface. The Listener Web Service interface is defined by the notification framework 10, and customized by the event listener 18. As with any Web Service, the interface is defined through a Web Service Definition Language (WSDL) document.

The notification framework 10 provides a Listener WSDL document through the event source publisher 24 that the event listener 18 obtains and implements. The Listener WSDL document is customized by the event listener 18 based upon the XSD documents that the event listener 18 wishes to understand; in other words, the types of events about which the event listener 18 wishes to receive notice.

Certain portions of the Listener WSDL document will be consistent, irrespective of the event listener, such as the definitions section, the binding section, and: the port type section.

Other portions of the Listener WSDL document are customized by the event listener 18. For example, in the import section, the WSDL document always imports the schema for an event envelope. The event envelope is a standard schema for packaging events by the notification framework 10. It includes a header with the event source information and a timestamp reflecting the time the raw event was received by the notification framework 10. The event envelope also includes event content, i.e. the details of the event. The structure of the event content is not specified in the schema for the event envelope. It is specified in the XSD document for each specific event type. Accordingly, the import section of the Listener WSDL document also imports the schemas for each event type about which the event listener 18 wishes to receive notice. The Listener WSDL document also contains a customized service section, wherein the event listener 18 specifies the address of the event listener 18 to which event messages are to be sent.

The import section of an event listener's Listener WSDL document defines the capability of the event listener 18. The schemas imported by the event listener 18 provide the event listener 18 with the capability of understanding events of that type. They are used to validate the event content of an event message.

An example of a Listener WSDL document is shown below:

<?xml version=“1.0” encoding=“utf-8”?>
<definitions
xmlns:http=“http://schemas.xmlsoap.org/wsdl/http/”
xmlns:soap=“http://schemas.xmlsoap.org/wsdl/soap/”
xmlns:s=“http://www.w3.org/2001/XMLSchema”
xmlns:s0=“http://www.nortelnetworks.com/ebn/playpus/
notification/Event”
xmlns:soapenc=“http://schemas.xmlsoap.org/soap/encoding/”
xmlns:tm=“http://microsoft.com/wsdl/mime/textMatching/”
xmlns:mime=“http://schemas.xmlsoap.org/wsdl/mime/”
xmlns:targetNamespace=“http://www.nortelnetworks.com/ebn/
platypus/notification/Event”
xmlns:“http://schemas.xmlsoap.org/wsdl/”>

| | |
|---|---|
| <import | namespace=“http://www.nortelnetworks.com/ebn/ |
| | platypus/notification/Event” |
| | schemaLocation=“GenericEvent”/> |
| <import | namespace=“specificEventNameSpaceURI001” |
| | schemaLocation=“specificEvent001.xsd”/> |
| <import | namespace=“specificEventNameSpaceURI002” |
| | schemaLocation=“specificEvent002.xsd”/> |

<types/>
<message name=“ForwardEventSoapIn”>

<part name=“theEvent” element=“s0:EventEnvelope”/>

</message>
<portType name=“EventListenerServiceSoap”>

<operation name=“ForwardEvent”>

<input message=“s0:ForwardEventInSoap”/>

</operation>

</portType>
<binding name=“EventListenerServiceSoap”

type=“s0:EventListenerServiceSoap”>

<soap:binding
transport=“http:schemas.xmlsoap.org/soap/http”
style=“document”/>
<operation name=“ForwardEvent”>

<soap:operation soapAction=“ForwardEvent”
style=“document”/>
<input>

<soap:body use=“literal”/>

</input>

</operation>

</binding>
<service name=“EventListenerService”>

<documentation>

This is an example of Listener Web Service.

</documentation>
<port name=“EventListenerServiceSoap”

binding=“s0:EventListenerServiceSoap”>
<soap:address location=“http://localhost/

EnerService.asmx”/>

</port>

</service>

</definitions>

The first document imported by the above example Listener WSDL document is a generic event schema defining the event envelope. The next two documents imported are specific to particular events. These two documents would be XSD documents selected by the event listener 18 based upon the namespace URI in event sources published by the event source publisher 24. The other customized portion of the Listener WSDL document is the service section wherein the local host address for the event listener 18 is given.

The above example Listener WSDL document defines a message “ForwardEventSoapIn” using the Event Envelope element. It then defines a “ForwardEvent” operation using the “ForwardEventSoapIn” message. The transport layer binding of the operation is defined as SOAP.

The notification framework 10 makes event forwarding decisions based upon event forwarding policies, which are stored in the event policy library 30. There are two types of policies, to reflect the two types of actions that are possible. One is an event source policy that includes an action to restrict the event listener targets. This policy specifies the event listeners to which events may be forwarded. The action contains a list of event listener URLs. This type of policy may be considered an event source filter that controls the list of possible event listeners. To be forwarded, an event must pass through the event source filter. Not every event generator 14 will have an associated event source policy.

The other type of policy is an event listener policy. This policy specifies the conditions under which an event is to be forwarded to a particular event listener 18. The event listener policy includes an action that indicates the target URL of event forwarding destination as well as re-sending, policies. This type of policy may be considered an event listener filter that controls the conditions under which an event may be forwarded to the event listener 18. An event that passes the event source filter must also pass the event listener filter. Every event listener 18 has an event listener policy, since the action in an event listener policy is necessary to send the event on to the event listener 18.

The policy model includes a condition and an action. A policy may be constructed in the following format:
If <condition(s)>then<action(s)>
   where the <condition(s)> term is a Boolean expression used to specify the rule selection criteria. There are three basic types of conditions in the notification framework 10: (1) event generator address conditions; (2) event receiving time conditions; and (3) event body/content conditions. It will be appreciated that other conditions may be used.

The event generator address condition specifies a list of event generator addresses. For example,.in an event listener policy a list of event generator addresses may be given as a condition, with the action indicating the event listener 18 to whom notice is to be forwarded if any of the listed event generators 14 produce an event.

The event receiving time condition specifies temporal conditions during which events should be forwarded. The temporal conditions may follow the time period data model specified in IETF RFC 3060. Complex time conditions may be supported, including begin time, end time, month mask, year mask, day of month mask, day of week mask and start time of day/end time of day. Other temporal conditions may also be used. By way of example, an event listener policy may impose a condition that only events generated between 8 am and 6 pm are to be forwarded to the event listener 18.

The event body condition specifies criteria about the type of event or the event content. Event content in the notification framework 10 is structured as an XML document. In one embodiment, the query language XPath is employed as a general purpose assertion language to express conditions on the event content. An XPath expression returns a node set. In one embodiment, if the number of nodes returned in the node set is not zero, then the assertion is considered to be true. The flexibility and schema independent nature of XPath syntax enables the notification framework 10 to express a wide variety of event body conditions. For example, in an event listener policy there may be a condition that only events that relate to a change of particular information are to be forwarded to the event listener 18. By way of example, an event type may be defined by the following XSD document:

<?xml version=“1.0” encoding=“UTF-8”?>
<xs:schema
targetNamespace=“http://www.nortelnetworks.com/ebn/platypus/schemas/subscriber.xsd”
xmlns:xs=“http://www.w3.org/2001/XMLSchema”
xmlns=“http://www.nortelnetworks.com/ebn/platypus/schemas/subscriber.xsd”
elementFormDefault=“qualified” attributeFormDefault=“unqualified”>

<xs:element name=“Subscriber”>

<xs:complexType>

<xs:sequence>

<xs:element name=“UniqueID” type=“xs:ID”/>
<xs:element ref=“Field” maxOccurs=“unbounded”/>

</xs:sequence>

</xs:complexType>

</xs:element>
<xs:element name=“Field”>

<xs:complexType>

<xs:sequence>

<xs:element name=“Name” type=“xs:string”/>
<xs:element name=“Type”>

<xs:simpleType>

<xs:restriction base=“xs:string”>

<xs:enumeration value=“Add”/>
<xs:enumeration value=“Delete”/>
<xs:enumeration value=“Change”/>

</xs:restriction>

</xs:simpleType>

</xs:element>
<xs:element name=“NewValue” type=“xs:anyType”/>
<xs:element name=“OldValue” type=“xs:anyType” minOccurs=“0”/>

</xs:sequence>

</xs:complexType>

</xs:element>

</xs:schema>

The event content described by the above schema document defines an element “Field”. The above example may relate to a database of phone numbers wherein a name is associated with a phone number. Two events conforming to the above event type may be generated by the event generator 14 as follows:

Event 1

<Subscriber>

<UniqueID>ID000000</UniqueID>
<Field>

<Name>DisplayName</Name>
<Type>Change</Type>
<NewValue>Bob</NewValue>
<OldValue>Peter</OldValue>

</Field>

</Subscriber>

Event 2

<Subscriber>

<UniqueID>ID000001</UniqueID>
<Field>

<Name>PhoneNumber</Name>
<Type>Change</Type>
<NewValue>1234</NewValue>
<OldValue>5678</OldValue>

</Field>

</Subscriber>

The event listener 18 may only wish to receive notice of changes to the names and not the phone numbers—that is, only Event 1, not Event 2. Accordingly, the event listener 18 may register an event listener policy with the notification framework 10 that includes the following XPath-condition on event content:
/Subscribers/Subscriber/Field[child::Name=‘DisplayName’]

Based upon the above condition, only Event 1 would be passed on to the event listener 18. Event 2 is filtered out on the basis that the event content within Event 2 does not contain the name ‘DisplayName’ within the Field element.

The three basic conditions, and any other conditions that may be developed, may be grouped within a single policy-using logical operators to express more complicated semantics.

Because every event listener 18 needs an event listener policy, a default policy is created when the event listener 18 is first registered. The default policy includes an event content condition that restricts the event content to those types of events that the event listener 18 is capable of understanding, i.e. those types of events for which the event listener 18 has imported an XSD document in establishing its Web Service Interface.

In one embodiment, the information in the event source library 20 and the event listener library 30 may be exploited to perform matchmaking amongst event generators 14 and event listeners 18. For example, automated event listener policies may be generated specifying the event generators 14 that are capable of generating events of the type that the event listener 18 is capable of consuming. Other automated matchmaking to generate forwarding policies may be implemented in other embodiments.

As a Web Service based application, the notification framework 10 defines its event forwarding policies in XSD documents and-exposes them through Web Service interfaces.

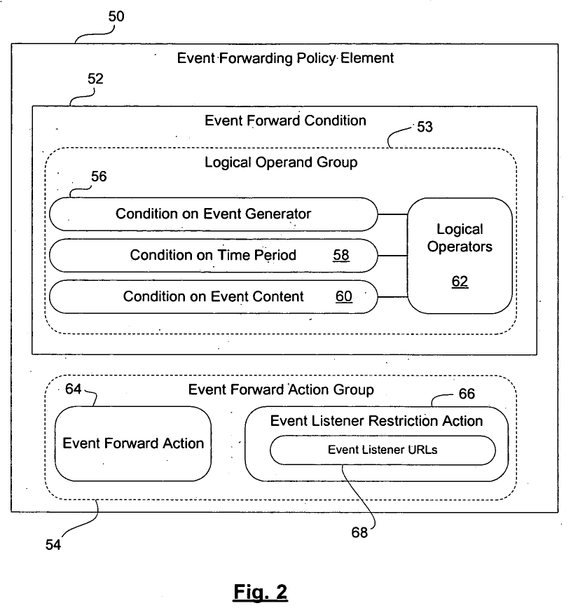

Reference is now made to FIG. 2, which diagrammatically shows the structure of an event forwarding policy element. 50. The event forwarding policy element 50 contains an event forward condition 52 and an event forward action group 54. The event forward condition 52 contains a logical operand group 53. The logical operand group 53 may contain a forward condition on event generator 56, a forward condition on time period 58, and a forward condition on event content 60. These forward conditions 56, 58, 60, may be combined through logical operators 62.

The event forward action group 54 may include an event forward action 64 or an event listener restriction action 66. The event forward action 64 is used in the case of an event listener policy and indicates an event listener target. It provides the target URL for the event listener 18 (FIG. 1) and any re-sending policies. This action run-time object forwards the event to the URL of the event listener 18.

The event listener restriction action 66 is used in the case of an event source policy and it provides a list 68 of event listener URLs to which events may be forwarded.

Using the two group elements, logical operand group 52 and event forward action group 54, the schema may be extended to accommodate new conditions and new actions into the two groups. Accordingly, the event forwarding policy element 50 is flexible and extensible.

Referring again to FIG. 1, it will be understood that the notification framework 10 functions to decouple the event generator 14 from the event listener 18. Event generators 14 need not know who they are sending event messages to; they send event messages to the notification framework 10 where all of the encapsulation and distribution is managed.

When an event is generated by the event generator 14 it sends a raw event message to the raw event handler 26. The raw event handler 26 parses the raw event message to extract the event content. It then repackages the event content within an event envelope. The event envelope allows for events from a variety of event generators to be repackaged into a consistent format for handling and distribution. The event listeners 18 that are registered to receive events of a particular type will be able to extract and understand the event content from the event envelope because they will have the schema for the event envelope and the schema for the particular event type.

The raw event handler 26 also incorporates a timestamp into the event envelope. The timestamp indicates the time at which the raw event message was received. This allows the notification framework 10 to operate asynchronously. Event listeners 18 will be able to process events in order based upon their timestamps, so the overall system need not wait for an event message to be received and responded to by the event listener 18 before proceeding to process the next event message. The incorporation of the timestamp into the generic event envelope permits the notification framework 10 to process a greater volume of events more quickly.

From the raw event handler 26, event envelopes are forwarded to the event message queue 28, where the event envelopes await processing/routing through the event policy library 30.

The event policy library 30 stores the filtering policies for determining the addresses of the event listeners 18 that should receive the event envelope and for completing the forwarding of event envelopes to event listeners 18. An event envelope is first filtered through any applicable event source policy to narrow down the list of potential event listeners. The event envelope is then filtered through the event listener policies. If an event source policy has narrowed down the list of potential event listeners, then only the event listener policies for those event listeners approved through the event source policy need be considered. If no other conditions have been specified in the event listener policies, then only the implicit default conditions will apply; namely, that only event listeners capable of understanding the event type will be entitled to receive the event envelope. In some embodiments, there may be other implicit default conditions for security or other reasons.

The event forwarding policy element 50 (FIG. 2) corresponding to an event listener policy includes the event forward action 64 (FIG. 2), which comprises a run-time object that forwards the event envelope to the event listener 18, subject to satisfaction of the event forward condition 52 (FIG. 2).

When the event listener 18 receives the event envelope, it is able to understand its structure based upon the event envelope schema that it imported in the creation of its Listener Web Service. It is also able to understand the structure and syntax of the event body/content based upon the XSD document it imported from the event schema library 22 in the creation of its Listener Web Service. The event envelope also contains the timestamp indicating the sequence in which the event listener 18 should process multiple events.

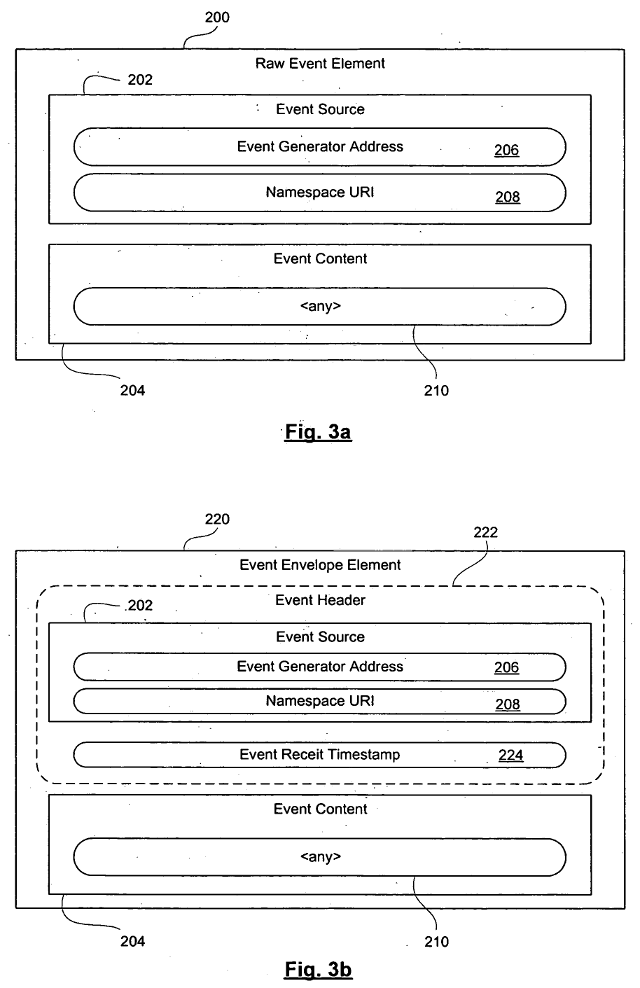

Reference is now made to FIGS. 3(a) and 3(b), which diagrammatically show the structure of a raw event element 200 and of an event envelope element 220, respectively. The raw event element 200 contains an event source 202 and event content 204. As discussed above, the event source 202 includes the event generator address 206 and the namespace URI 208 for obtaining the XSD document corresponding to the event type.

The event content 204 includes an <any> element 210 indicating that the event content 204 may be structured in any manner consistent with the XSD document specified through the namespace URI 208. This provides for flexibility in accommodating newly-defined event types within the notification framework 10 (FIG. 1).

The event envelope element 220 includes an event header 222 that incorporates the event source 202 information along with an event receipt timestamp 224. The event envelope element 220 also includes the event content 204.

The event envelope does not contain any information specifying the recipients of the event message.

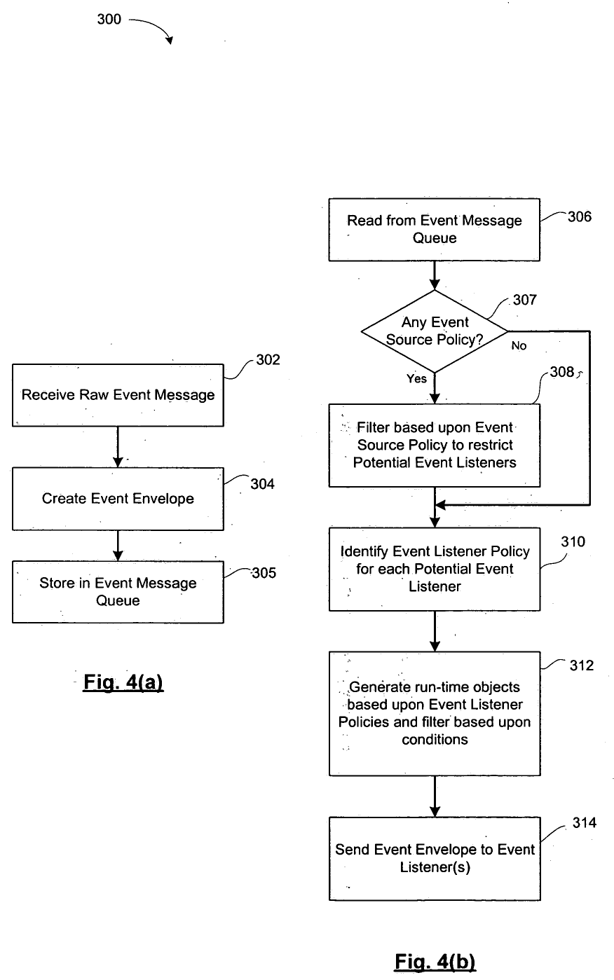

Reference is now made to FIGS. 4(a) and 4(b), which show flowcharts for a method 300 of distributing notification regarding an event from an event generator to an event listener in a network environment.

The method 300 begins in step 302 with the receipt of a raw event message from an event generator. The raw event message contains event content providing details about the event. The event may, for example, be a change in the status or availability of a network element, or it may, for example, be a change to a data field in a document or database. An example of the latter case is a change to a telephone number in a database containing telephone numbers. In such an example, the event content may include the old telephone number, the new telephone number, and any associated information, such as the effective date of the change or the identity of the person corresponding to the telephone number. Events may also be related to fault monitoring or other network management tasks. Events may occur in myriad other circumstances and contexts. As described above, the notification framework 10 is designed to accommodate a variety of new event types, howsoever the structure and semantics of the event content may be specified through the corresponding XSD document.

Once the raw event message has been received, in step 304 an event envelope is created. The event envelope places the event source information and a timestamp into the header and encapsulates the event content from the raw event message. Then, in step 305, the event envelope is placed in an event message queue to await further processing by the notification framework 10. The use of an event message queue permits the notification framework 10 to operate asynchronously.

At some point later, the event envelope is read from the event message queue, in step 306. Then in step 307, based upon the event source information, the event policy library 30 (FIG. 1) is searched for an event source policy. If an event source policy is located, then the method 300 proceeds to step 308. The event source policy is expressed through an event forwarding policy element 50 (FIG. 2) having an event listener restriction action 66 (FIG. 2) for restricting the potential event listeners. This restriction action is generated by the event forward policy element in step 308.

For each of the potential event listeners, in step 310 the event policy library 30 is searched to identify the event listener policy that corresponds to each potential event listener. If no event source policy has lead to a restriction of event listeners, then all event listener policies will be utilized. If an event source policy resulted in a restriction action, then only the event listener policies for the ‘surviving’ event listeners are relevant.

An event listener policy is expressed through an event forwarding policy element 50 having an event forward action 64 (FIG. 2) run-time object that forwards the event envelope to the event listener, subject to satisfaction of the event forward conditions in the event forwarding policy element 50. For each potential event listener that satisfies the event forward conditions in its respective event listener policy, there is a run-time action object. As discussed above, at a minimum, the conditions in an event listener policy include a restriction on the event content to the type of events that the event listener is capable of understanding.

In step 314, the action run-time objects for those Event Listener Policies that meet their respective event forward conditions send the event envelope to the event listeners in step 314.

Referring again to FIG. 1, it will be understood that the asynchronous and decoupled nature of the notification framework 10 allows for an offline work mode. In particular, the notification framework 10 supports three offline work modes: event generator offline, event listener offline, and notification framework offline.

The event generator offline mode occurs when the event generator 14 is unable to establish a connection with the notification framework 10. In this case, events generated during an offline period are stored at the event generator 14 in an outgoing message queue until the network connection to the notification framework is re-established. In one embodiment, the event generator 14 uses a Microsoft Message Queue service installed at the event generator 14 to queue outgoing messages.

The event listener offline mode occurs when the network connection between event listener 18 and the notification framework 10 is down. In this case, events for forwarding to the event listener 18 will be sent to an alternate event listener if one is specified in the corresponding event listener policy. The event listener policy may also specify re-send policies, in which case the event message will be placed in a re-send queue.

The notification framework 10 offline mode occurs when the notification service is temporarily unavailable. The may occur, for example, if the service is paused by an administrator or by an unhandled software exception. In this mode, events received by the raw event handler 26 are repackaged into event envelopes, as usual, and are stored in the event message queue 28 for later handling by the notification service. Once the notification service is brought back on-line, the queued events are handled in a first-in first-out (FIFO) fashion.

The notification framework 10 also provides for scalability. In a case where there are high volume events, multiple instances of the notification service may be provided to handle groups of event generators. The event source library 20, the event schema library 22, the event listener library 32, and the event policy library 30 may be persisted in a central server. Event generators may then be divided into groups amongst the instances of the notification service according to their event volume requirements.

In this embodiment, in order to synchronize library changes every instance of the notification service is an event listener for library change events. One of the instances is a “master” instance to route these types of events to other instances. For example, a new event listener may be registered through instance three, where instance one is the master instance. In this example, instance three saves the change to the event listener library 32 and raises a library change event to instance one. Instance one then forwards this event to all other instances' Listener Web Service Interfaces.

In another embodiment, a web service dispatcher receives incoming events from event generators and distributes them among the various instances of the notification service in order to perform load balancing. The web service dispatcher may distribute events in sequential order or may adopt other scheduling or load balancing algorithms.

In yet another embodiment, a policy decision point may be introduced between the central server and the instances of the notification service. The policy decision point allocates responsibility for particular event forwarding policies amongst the instances. This configuration may be useful in embodiments having complicated event forwarding policies requiring significant processing delay. If all instances were required to process all policies, excessive delay may result, so the present embodiment divides the policies among the instances and in essence processes the policies in parallel. Each instance is thus a policy enforcement point. Accordingly, the web service dispatcher dispatches events to each instance of the notification service. One of the instance still acts as a master instance to synchronize library changes.

In a further embodiment, the parallel processing embodiment may include a user interface permitting the user to assign policies to particular subgroups or to create new subgroups.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

1. A method of distributing notification regarding an event from an event generator to an event listener in a network environment, the method comprising the steps of:
(a) receiving an event message from the event generator, said event message being Web Service based and including an event source element and an extensible event content element;
(b) creating an event envelope containing said event content element;
(c) identifying the event listener as a registered event listener entitled to receive notice of the event; and
(d) transmitting the event envelope to the event listener.

2. The method claimed in claim 1, wherein said event envelope includes a timestamp.

3. The method claimed in claim 2, wherein said timestamp includes a time of receipt of said event message.

4. The method claimed in claim 1, wherein said event source element comprises an event generator address for the event generator and an event type identifier.

5. The method claimed in claim 4, wherein said event type identifier corresponds to a schema, and wherein said schema defines a structure for said event content element.

6. The method claimed in claim 5, further including steps of registering the event generator, storing said event source element in an event source library, and storing said schema in an event schema library.

7. The method claimed in claim 4, further including a step of publishing said event source element through a Web Service Interface.

8. The method claimed in claim 7, further including steps of providing the event listener with said event source element, including an associated schema, through said Web Service Interface, and implementing a Listener Web Service Interface incorporating said associated schema at the event listener.

9. The method claimed in claim 7, further including a step of matching the event generator and the event listener based upon the event listener having implemented a Listener Web Service Interface incorporating a schema associated with the event type identifier.

10. The method claimed in claim. 1, further including a step of receiving an event policy and wherein said step of identifying includes applying said event policy.

11. The method claimed in claim 10, wherein said event policy is received from the event generator or the event listener.

12. The method claimed in claim 10, wherein said event policy includes a condition and an action, and wherein said action comprises a run-time object.

13. The method claimed in claim 12, wherein said condition comprises a condition upon said extensible event content element, and wherein said condition is expressed using X-Path language.

14. The method claimed in claim 1, wherein said event content element is an XML document, and wherein the structure of said XML document is defined by an XSD document.

15. The method claimed in claim 1, wherein said step of creating further includes storing said event envelope in a message queue.

16. A notification framework for distributing notification regarding an event from an event generator to an event listener in a network environment, the notification framework including:
(a) an event handler for receiving an event message from the event generator, the event message being Web Service based and including an event source element and an extensible event content element, and encapsulating the event content element in an event envelope;
(b) an event listener library identifying registered event listeners entitled to receive notice of the event, wherein said registered event listeners include the event listener; and
(c) an event policy library including an event policy element for transmitting the event envelope to the event listener.

17. The notification framework claimed in claim 16, wherein said event envelope includes a timestamp.

18. The notification framework claimed in claim 17, wherein said timestamp includes a time of receipt of said event message.

19. The notification framework claimed in claim 16, further including an event source library, wherein said event source library contains said event source element, said event source element comprising an event generator address for the event generator and an event type identifier.

20. The notification framework claimed in claim 19, further including an event schema library, wherein said event schema library includes a schema document corresponding to said event type identifier, and wherein said schema document defines a structure for said event content element.

21. The notification framework claimed in claim 19, further including an event source publisher for publishing said event source element through a Web Service Interface.

22. The notification framework claimed in claim 21, wherein said event source publisher further publishes a Web Service Definition Language document for implementation by the event listener, said Web Service Definition Language document importing a schema defining the structure of said event envelope and a schema defining the structure of said event content element.

23. The notification framework claimed in claim 16, wherein said event policy element includes a condition and an action, and wherein said action comprises a run-time object.

24. The notification framework claimed in claim 23, wherein said condition comprises a condition upon said extensible event content element and wherein said condition is expressed using XPath language.

25. The notification framework claimed in claim 16, wherein said event content element comprises an XML document, and wherein the structure of said XML document is defined by an XSD document.

26. The notification framework claimed in claim 16, further including a message queue for receiving and storing said event envelope from said event handler prior to transmission by said event policy element.

27. A computer program product having a computer readable medium tangibly embodying computer executable instructions for distributing notification regarding an event from an event generator to an event listener in a network environment, the computer executable instructions comprising:
(a) computer executable instructions for receiving an event message from the vent generator, said event message being Web Service based and including an event source element and an extensible event content element;
(b) computer executable instructions for creating an event envelope containing said event content element;
(c) computer executable instructions for identifying the event listener as a registered event listener entitled to receive notice of the event; and
(d) computer executable instructions for transmitting the event envelope to the event listener.

28. The computer program product claimed in claim 27, wherein said event envelope includes a timestamp.

29. The computer program product claimed in claim 28, wherein said timestamp includes a time of receipt of said event message.

30. The computer program product claimed in claim 27, wherein said event source element comprises an event generator address for the event generator and an event type identifier.

31. The computer program product claimed in claim 30, wherein said event type identifier corresponds to a schema, and wherein said schema defines a structure for said event content element.

32. The computer program product claimed in claim 31, further including computer executable instructions for registering the event generator, storing said event source element in an event source library, and storing said schema in an event schema library.

33. The computer program product claimed in claim 30, further including computer executable instructions for publishing said event source element through a Web Service Interface.

34. The computer program product claimed in claim 33, further including computer executable instructions for providing the event listener with said event source element, including an associated schema, through said Web Service Interface, and computer executable instructions for implementing a Listener Web Service Interface incorporating said associated schema.

35. The computer program product claimed in claim 33, further including computer executable instructions for matching the event generator and the event listener based upon the event listener having implemented a Listener Web Service Interface incorporating a schema associated with the event type identifier.

36. The computer program product claimed in claim 27, further including computer executable instructions for receiving an event policy and wherein said computer executable instructions for identifying include computer executable instructions for applying said event policy.

37. The computer program product claimed in claim 36, wherein said event policy is received from the event generator or the event listener.

38. The computer program product claimed in claim 36, wherein said event policy includes a condition and an action, and wherein said action comprises a run-time object.

39. The computer program product claimed in claim 38, wherein said condition comprises a condition upon said extensible event content element, and wherein said condition is expressed using X-Path language.

40. The computer program product claimed in claim 27, wherein said event content element is an XML document, and wherein the structure of said XML document is defined by an XSD document.

41. The computer program product claimed in claim 27, wherein said computer executable instructions for creating further include computer executable instructions for storing said event envelope in a message queue.
